(19) United States
(12) Patent Application Publication
(10) Pub. No.: US 2025/0056604 A1
(43) Pub. Date: Feb. 13, 2025

(54) COT RESERVATION AND SHARING FOR UNICAST AND MULTICAST SIDELINK UNLICENSED

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, CT (US)

(21) Appl. No.: 18/801,538

(22) Filed: Aug. 12, 2024

Related U.S. Application Data
(60) Provisional application No. 63/531,844, filed on Aug. 10, 2023.

(51) Int. Cl. H04W 74/0808; H04W 72/25

(52) U.S. Cl. CPC H04W 74/0808; H04W 72/25

(57) ABSTRACT

A method of sidelink communications includes transmitting, by a first user equipment (UE), control information comprising channel occupancy time (COT) reservation information associated with one or more COTs and in response to a listen before talk (LBT) process indicating a clear channel, transmitting on a first COT of the one or more COTs, based on a maximum COT duration.

### CROSS-REFERENCE TO RELATED APPLICATIONS

This application claims priority under 35 USC § 119(e) from U.S. Provisional Patent Application No. 63/531,844, filed on Aug. 10, 2024 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to systems and/or methods for managing channel occupancy time (COT) sharing for unicast and/or groupcast, which may need enhancements to existing control signaling. Example embodiments enhance Channel Occupancy Time signaling and sharing with Receiving user equipments (UEs).

In an embodiment, the invention provides a A method of sidelink communications includes transmitting, by a first user equipment (UE), control information comprising channel occupancy time (COT) reservation information associated with one or more COTs and in response to a listen before talk (LBT) process indicating a clear channel, transmitting on a first COT of the one or more COTs, based on a maximum COT duration. Preferably, the control information comprises sidelink control information (SCI). The sidelink control information (SCI) may comprises a first stage SCI. The first stage sidelink control information (SCI) may be transmitted, by the first user equipment (UE), via a physical sidelink control channel (PSCCH).

The sidelink control information (SCI) may further comprise a second stage SCI. The second stage sidelink control information (SCI) is transmitted, by the first user equipment (UE), via a physical sidelink shared channel (PSSCH). In the method, the sidelink control information (SCI) may comprise a first stage SCI and a second stage SCI and at least a first portion of the channel occupancy time (COT) reservation information associated with the one or more COTs is transmitted based on the first stage SCI and at least a second portion of said COT reservation information may be transmitted based on the second stage SCI. Each of the one or more channel occupancy times (COTs) may start from different times.

In the method, a first channel occupancy time (COT) can be an earliest COT, of the one or more COTs, for which a listen before talk (LBT) process indicates a clear channel. For that matter, the one or more channel occupancy times (COTs) consists of a single COT with an extended duration, and wherein the transmitting, by the first user equipment (UE), starts in a timing within the single COT for which the listen before talk (LBT) process indicates a clear channel. The extended duration may be longer than the maximum channel occupancy time (COT) duration. The maximum channel occupancy time (COT) duration can be based on a network configuration or based on a regulation. The maximum channel occupancy time (COT) duration may be based on a network configuration or based on a regulation. The method also can include transmitting signaling indicating that at least a portion of the one or more reserved channel occupancy times (COTs) are not used.

In the method, the control information may indicate one or more of: a priority; frequency and time resource assignment; resource reservation period; demodulation reference signal (DMRS) pattern and a number of DMRS ports; a second stage sidelink control information (SCI) format; and modulation and coding scheme. The priority may indicate a channel access priority class (CAPC). The frequency and resource assignment may be indicated for each of one or more channel occupancy times (COTs). The control information indicates an update to a previously indicated channel occupancy time (COT) information. The method can also include receiving one or more configuration parameters indicating enabling at least one of channel occupancy time (COT) reservation and COT sharing. The receiving the one or more configuration parameters is based on a radio resource control (RRC) message.

The control information may further include channel occupancy time (COT) sharing information. The method may further comprise sharing a channel occupancy time (COT) by a second user equipment (UE) based on the COT sharing information. The sharing the channel occupancy time (COT) by the second user equipment (UE) may be based on a channel access priority class (CAPC) associated with the COT. The sharing the channel occupancy time (COT) by the second user equipment (UE) may be for transmission of hybrid automatic repeat request (HARQ) feedback. The transmission of the hybrid automatic repeat request (HARQ) feedback may be via a physical sidelink feedback channel (PSFCH). The channel occupancy time (COT) sharing information can indicate a group of one or more user equipments (UEs) in which the COT sharing is allowed.

For that matter, the group of the one or more user equipments (UEs) is a multicast group. Preferably, other user equipments (UEs) that are not in the multicast group are not allowed to participate in the channel occupancy time (COT) sharing. The channel occupancy time (COT) sharing information may indicate an identifier of the multicast group. The identifier may be an L1/L2 multicast destination identifier. The method might further comprise receiving one or more configuration parameters indicating the identifier. In that case, the one or more configuration parameters may received via a radio resource control (RRC) message. The channel occupancy time (COT) sharing may be for a physical sidelink feedback channel (PSFCH) and the COT sharing information may indicate that the COT sharing is associated with any one of a positive acknowledgement (ACK), a negative acknowledgement (NACK) and both of ACK and NACK.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16A and FIG. 16 B show examples of Multi-COT (a) and Extended COT (b) Reservation and Un-Reservation signaling according to some aspects of some of various exemplary embodiments of the present disclosure.

FIG. 17 shows an example of COT Reservation and Sharing Information split in 1st and 2nd Stage SCI according to some aspects of some of various exemplary embodiments of the present disclosure.

FIG. 18 shows an example of Groupcast Destination ID set to control COT sharing among a group of 4 Users according to some aspects of some of various exemplary embodiments of the present disclosure.

FIG. 19 shows an example process according to some aspects of some of various exemplary embodiments of the present disclosure.

### DETAILED DESCRIPTION

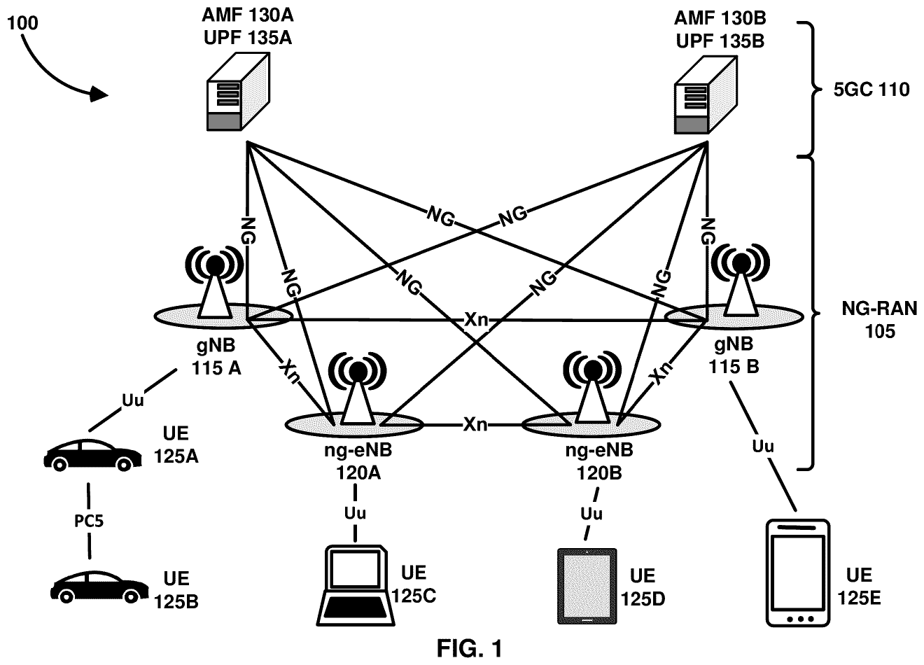

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

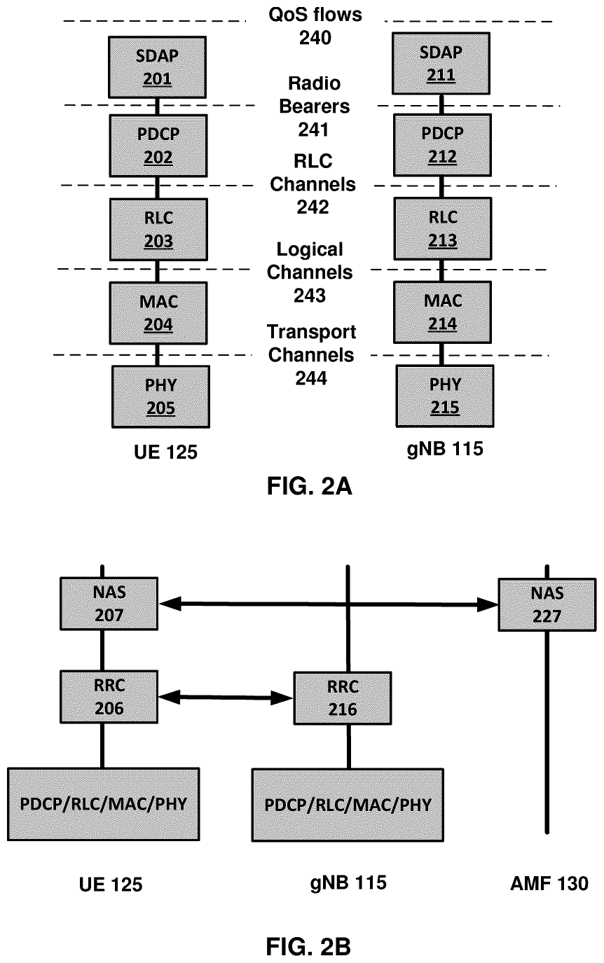

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

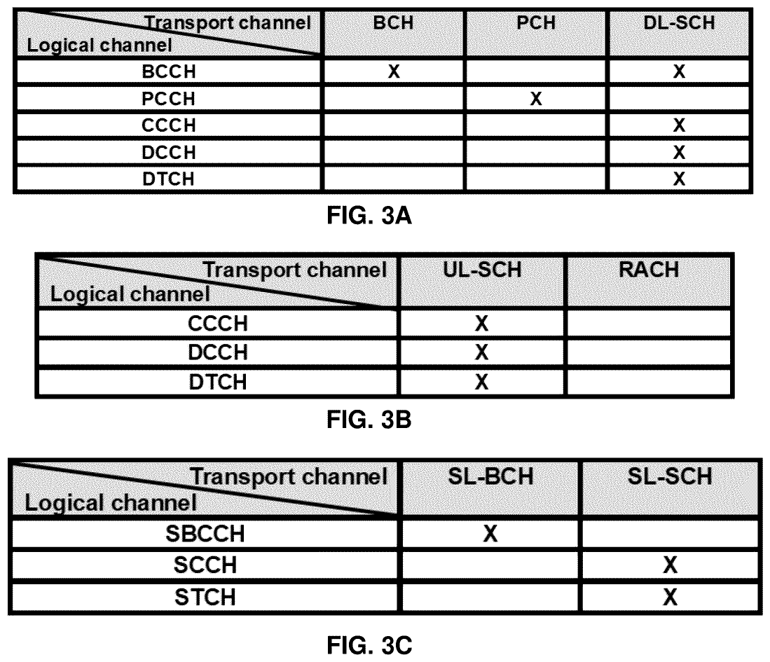

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and networks. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

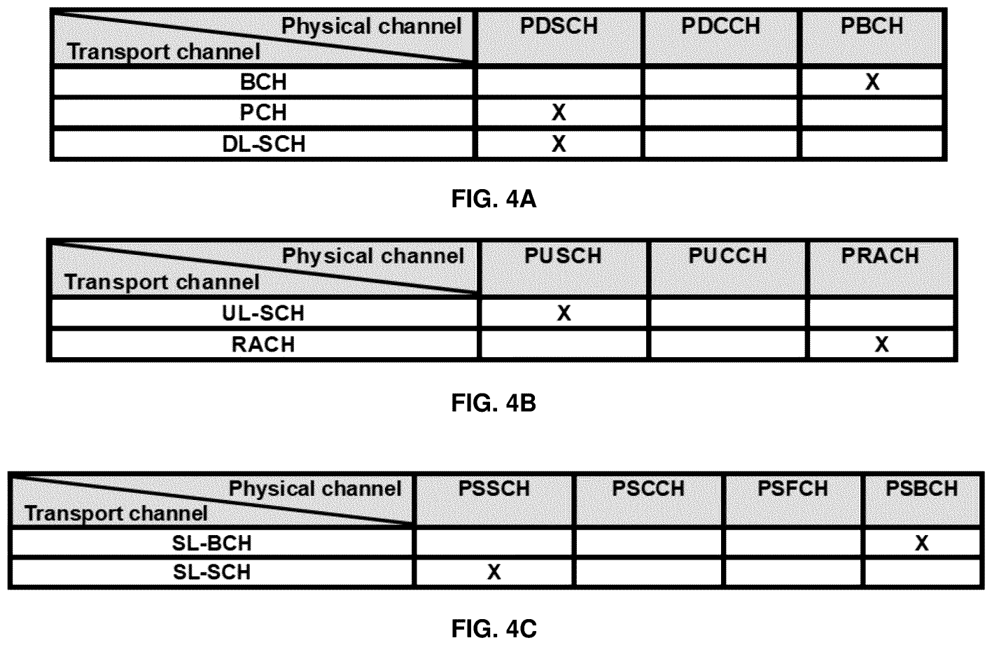

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

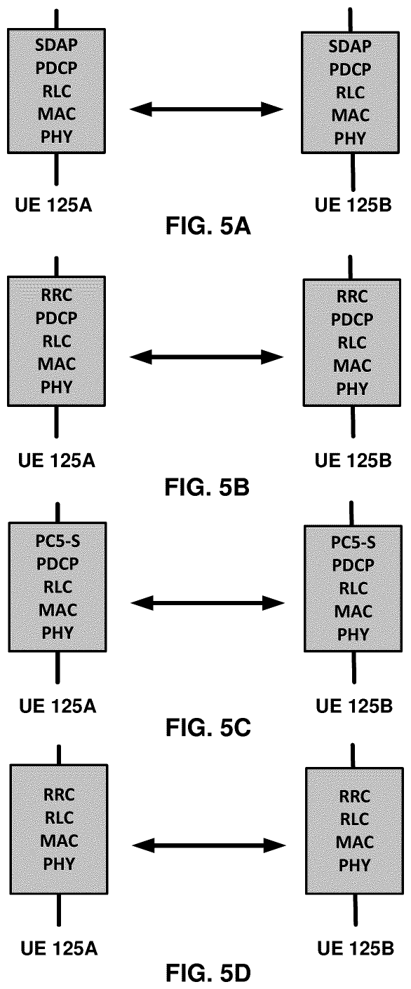

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

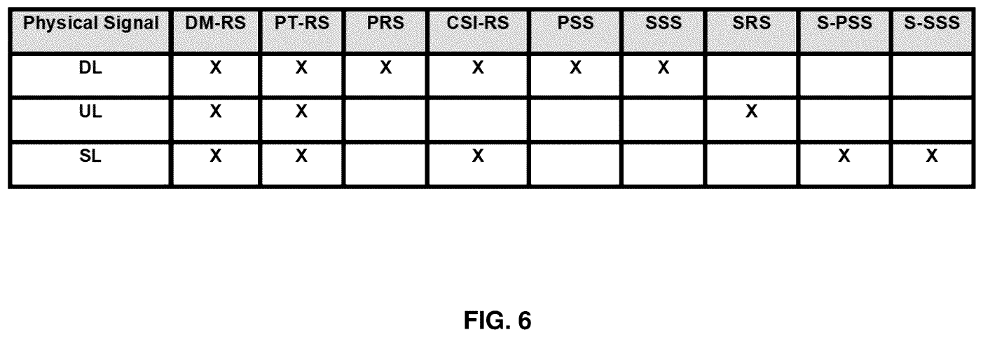

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transmit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

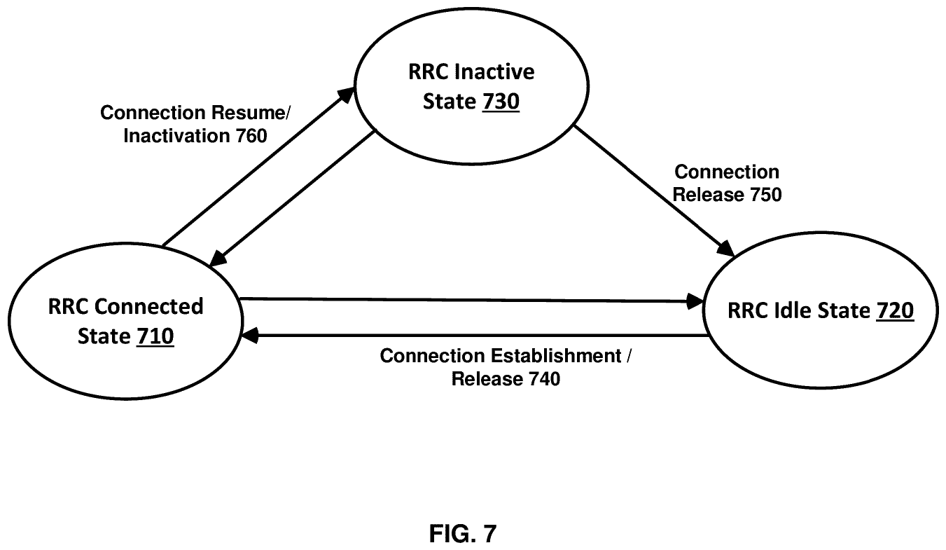

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

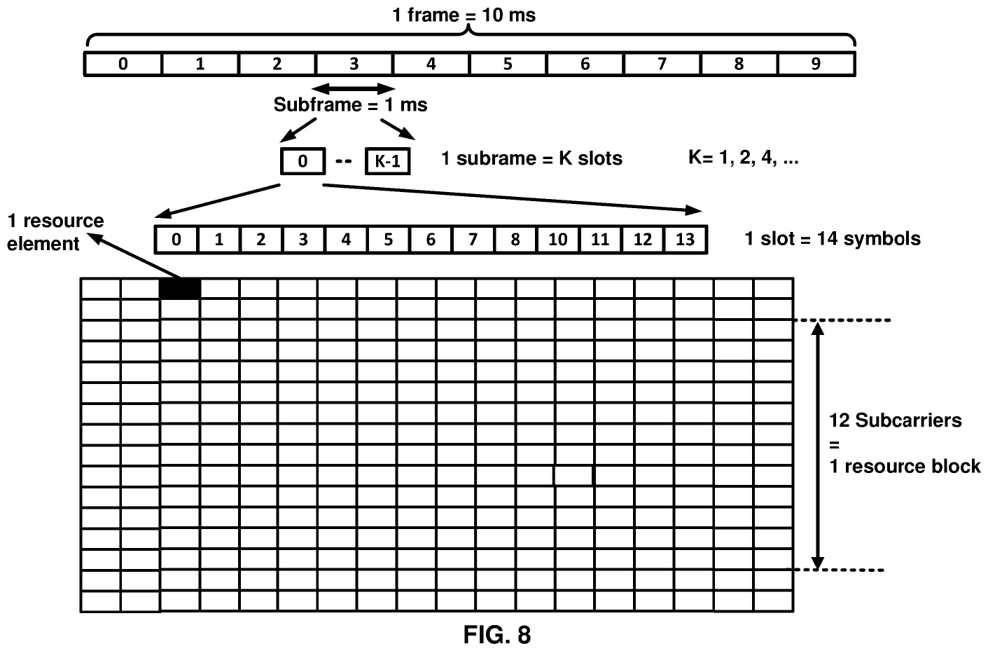

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

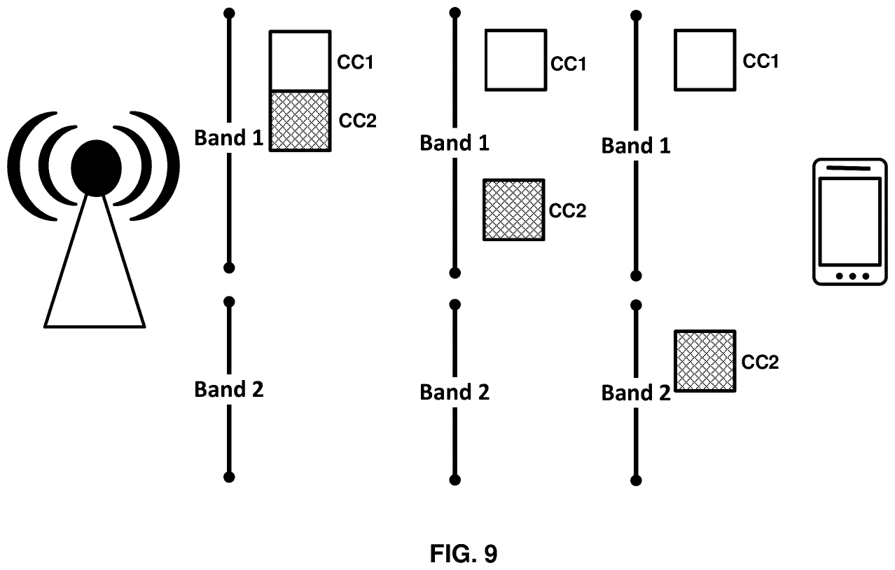

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated with at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

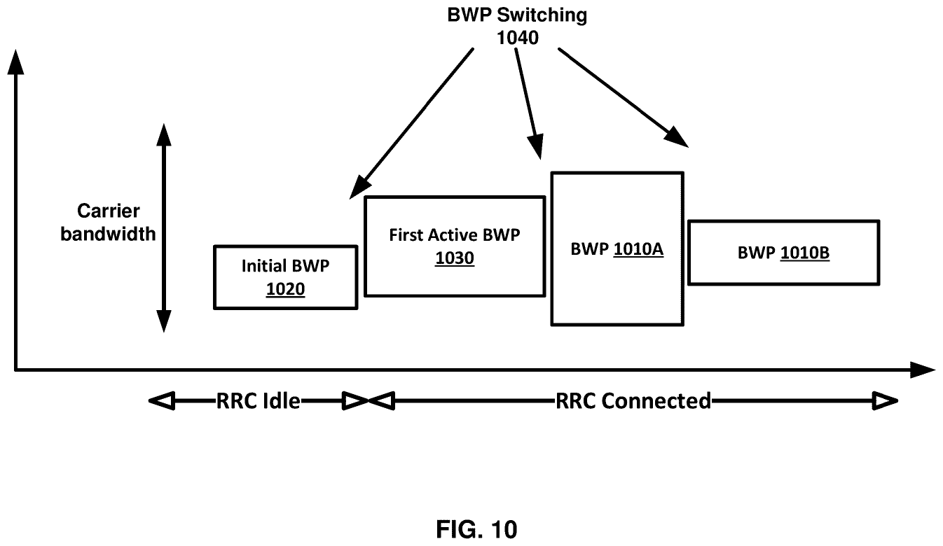

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g., to increase scheduling flexibility); and the subcarrier spacing may be ordered to change (e.g., to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

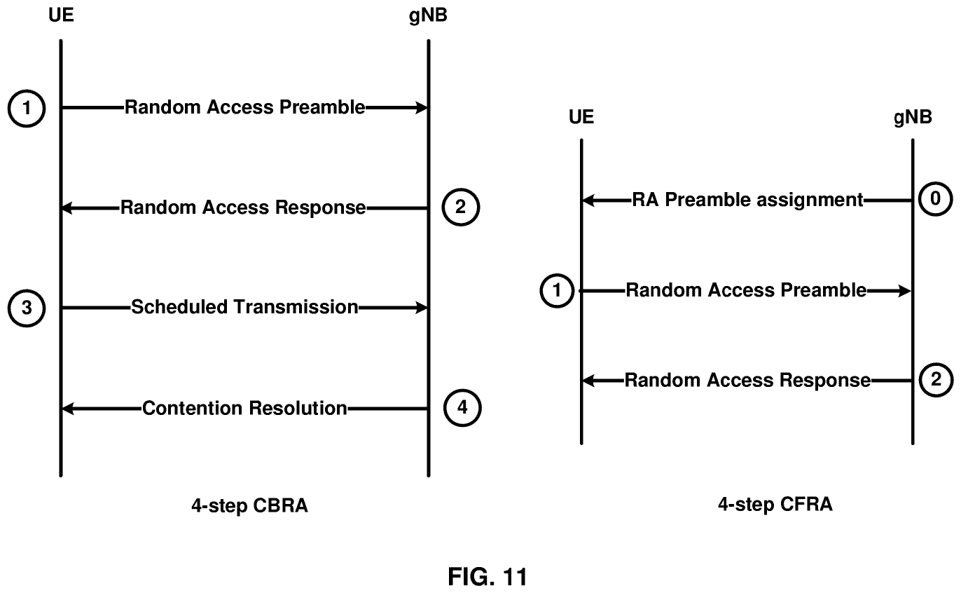

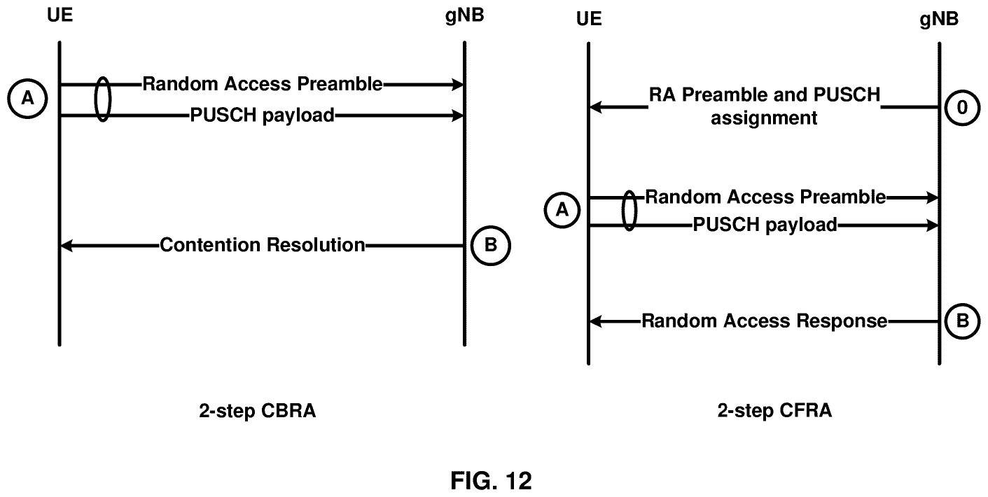

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, an RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

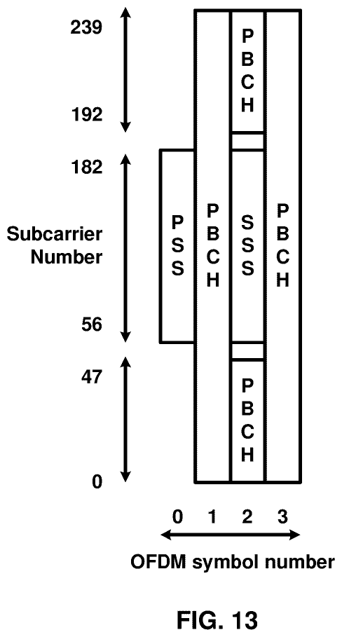

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

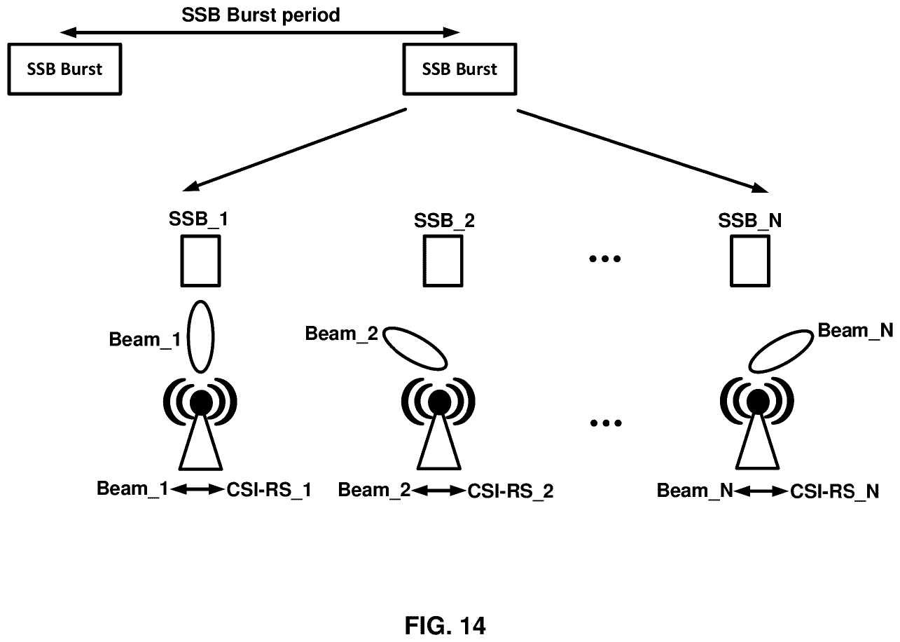

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

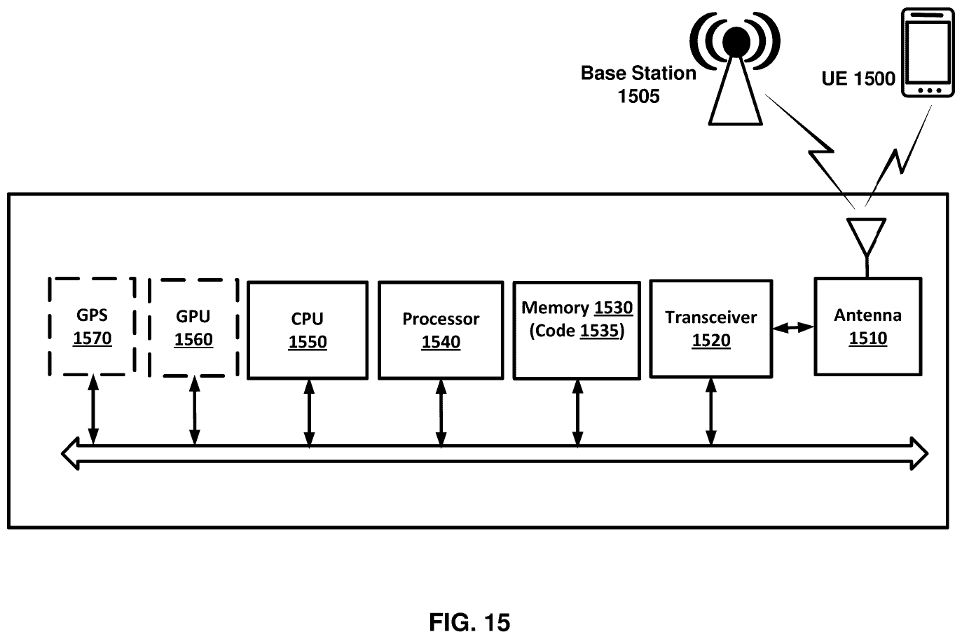

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples, depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, for NR sidelink communication, the UE may operate in two modes for resource allocation in sidelink: Scheduled resource allocation and UE autonomous resource selection. Scheduled resource allocation may be characterized by: The UE needs to be RRC_CONNECTED in order to transmit data; and NG-RAN schedules transmission resources. UE autonomous resource selection may be characterized by: The UE may transmit data when inside NG-RAN coverage, irrespective of which RRC state the UE is in, and when outside NG-RAN coverage; and The UE autonomously selects transmission resources from resource pool(s). In some examples, for NR sidelink communication, the UE may perform sidelink transmissions only on a single carrier.

In some examples, NG-RAN may dynamically allocate resources to the UE via the SL-RNTI on PDCCH(s) for NR sidelink communication.

In some examples, in addition, NG-RAN may allocate sidelink resources to a UE with two types of configured sidelink grants: With type 1, RRC may directly provide the configured sidelink grant only for NR sidelink communication; With type 2, RRC may define the periodicity of the configured sidelink grant while PDCCH can either signal and activate the configured sidelink grant or deactivate it. The PDCCH may be addressed to SL-CS-RNTI for NR sidelink communication.

In some examples, NG-RAN may semi-persistently allocate sidelink resources to the UE via the SL Semi-Persistent Scheduling V-RNTI on PDCCH(s) for V2X sidelink communication.

In some examples, for the UE performing NR sidelink communication, there may be more than one configured sidelink grant activated at a time on the carrier configured for sidelink transmission.

In some examples, when beam failure or physical layer problem occurs on MCG, the UE may continue using the configured sidelink grant Type 1 until initiation of the RRC connection re-establishment procedure. During handover, the UE may be provided with configured sidelink grants via handover command, regardless of the type. If provided, the UE may activate the configured sidelink grant Type 1 upon reception of the handover command or execution of CHO.

In some examples, the UE may send sidelink buffer status report to support scheduler operation in NG-RAN. For NR sidelink communication, the sidelink buffer status reports may refer to the data that is buffered in for a group of logical channels (LCG) per destination in the UE. Eight LCGs may be used for reporting of the sidelink buffer status reports. Two formats, which may be SL BSR and truncated SL BSR, may be used.

In some examples, the UE may autonomously select sidelink resource(s) from resource pool(s) provided by broadcast system information or dedicated signalling while inside NG-RAN coverage or by pre-configuration while outside NG-RAN coverage.

In some examples, for NR sidelink communication, the resource pool(s) may be provided for a given validity area where the UE does not need to acquire a new pool of resources while moving within the validity area, at least when this pool is provided by SIB. The NR SIB area scope mechanism may be reused to enable validity area for SL resource pool configured via broadcasted system information.

In some examples, the UE may be allowed to temporarily use UE autonomous resource selection with random selection for sidelink transmission based on configuration of the exceptional transmission resource pool.

In some examples, when a UE is inside NG-RAN coverage, NR sidelink communication and/or V2X sidelink communication may be configured and controlled by NG-RAN via dedicated signalling or system information: The UE may support and may be authorized to perform NR sidelink communication and/or V2X sidelink communication in NG-RAN; If configured, the UE may perform V2X sidelink communication unless otherwise specified, with the restriction that the dynamic scheduling for V2X sidelink communication (i.e. based on SL-V-RNTI) may not be supported; NG-RAN may provide the UE with intra-carrier sidelink configuration, inter-carrier sidelink configuration and anchor carrier(s) which may provide sidelink configuration via a Uu carrier for NR sidelink communication and/or V2X sidelink communication; When the UE cannot simultaneously perform both NR sidelink transmission and NR uplink transmission in time domain, prioritization between both transmissions may be done based on their priorities and thresholds configured by the NG-RAN or preconfigured. When the UE cannot simultaneously perform both V2X sidelink transmission and NR uplink transmission in time domain, prioritization between both transmissions may be done based on the priorities (i.e., PPPP) of V2X sidelink communication and a threshold configured by the NG-RAN or preconfigured.

In some examples, when a UE is outside NG-RAN coverage, SL DRB configuration(s) may be preconfigured to the UE for NR sidelink communication. If UE changes the RRC state but has not received the SL DRB configuration(s) for the new RRC state, UE may continue using the configuration obtained in the previous RRC state to perform sidelink data transmissions and receptions until the configuration for the new RRC state is received.

In some examples, the UE in RRC_CONNECTED may perform NR sidelink communication and/or V2X sidelink communication, as configured by the upper layers. The UE may send Sidelink UE Information to NG-RAN in order to request or release sidelink resources and report QoS information for each destination.

In some examples, NG-RAN may provide RRCReconfiguration to the UE in order to provide the UE with dedicated sidelink configuration. The RRCReconfiguration may include SL DRB configuration(s) for NR sidelink communication as well as mode 1 resource configuration and/or mode 2 resource configuration. If UE has received SL DRB configuration via system information, UE may continue using the configuration to perform sidelink data transmissions and receptions until a new configuration is received via the RRCReconfiguration.

In some examples, NG-RAN may configure measurement and reporting of CBR for NR sidelink communication and V2X sidelink communication and reporting of location information for V2X sidelink communication to the UE via RRCReconfiguration.

In some examples, during handover, the UE may perform sidelink transmission and reception based on configuration of the exceptional transmission resource pool or configured sidelink grant Type 1 (for NR sidelink communication only) and reception resource pool of the target cell as provided in the handover command.

In some examples, the UE in RRC_IDLE or RRC_INACTIVE may perform NR sidelink communication and/or V2X sidelink communication, as configured by the upper layers. NG-RAN may provide common sidelink configuration to the UE in RRC_IDLE or RRC_INACTIVE via system information for NR sidelink communication and/or V2X sidelink communication. UE may receive resource pool configuration and SL DRB configuration via SIB12 for NR sidelink communication, and/or resource pool configuration via SIB13 and SIB14 for V2X sidelink communication.

In some examples, when the UE performs cell reselection, the UE interested in V2X service(s) may consider at least whether NR sidelink communication and/or V2X sidelink communication are supported by the cell. The UE may consider the following carrier frequency as the highest priority frequency, except for the carrier only providing the anchor carrier: the frequency providing both NR sidelink communication configuration and V2X sidelink communication configuration, if configured to perform both NR sidelink communication and V2X sidelink communication; the frequency providing NR sidelink communication configuration, if configured to perform only NR sidelink communication; the frequency providing V2X sidelink communication configuration, if configured to perform only V2X sidelink communication.

In some examples, the UE may perform NR sidelink discovery while in-coverage or out-of-coverage for non-relay operation. In some examples, the Relay discovery mechanism (except the U2N Relay specific threshold based discovery message transmission) may be applied to sidelink discovery.

In some examples, Sidelink may support SL DRX for unicast, groupcast, and broadcast. Similar parameters as defined for Uu (on-duration, inactivity-timer, retransmission-timer, cycle) may be defined for SL to determine the SL active time for SL DRX. During the SL active time, the UE may perform SCI monitoring for data reception (i.e., PSCCH and 2nd stage SCI on PSSCH). The UE may skip monitoring of SCI for data reception during SL DRX inactive time.

In some examples, the SL active time of the RX UE may include the time in which any of its applicable SL on-duration timer(s), SL inactivity-timer(s) or SL retransmission timer(s) (for any of unicast, groupcast, or broadcast) are running. In some examples, the slots associated with announced periodic transmissions by the TX UE and the time in which a UE is expecting CSI report following a CSI request (for unicast) may be considered as SL active time of the RX UE.

In some examples, a TX UE may maintain a set of timers corresponding to the SL DRX timers in the RX UE(s) for each pair of source/destination L2 ID for unicast or destination L2 ID for groupcast/broadcast. When data is available for transmission to one or more RX UE(s) configured with SL DRX, the TX UE may select resources taking into account the active time of the RX UE(s) determined by the timers maintained at the TX UE.

In some examples, a UE may determine from SIB12 whether the gNB supports SL DRX or not.

In some examples, a default SL DRX configuration for groupcast/broadcast may be used for discovery message in sidelink discovery and for relay discovery messages.

In some examples, for unicast, SL DRX may be configured per pair of source L2 ID and destination L2 ID.

In some examples, the UE may maintain a set of SL DRX timers for each direction per pair of source L2 ID and destination L2 ID. The SL DRX configuration for a pair of source/destination L2 IDs for a direction may be negotiated between the UEs in the AS layer. For SL DRX configuration of each direction, where one UE is the TX UE and the other is the RX UE: RX UE may send assistance information, which may include its desired SL on-duration timer, SL DRX start offset, and SL DRX cycle, to the TX UE and the mode 2 TX UE may use it to determine the SL DRX configuration for the RX UE; Regardless of whether assistance information is provided or not, the TX UE in RRC_IDLE/RRC_INACTIVE/OOC, or in RRC_CONNECTED and using mode 2 resource allocation, may determine the SL DRX Configuration for the RX UE. For a TX UE in RRC_CONNECTED and using mode 1 resource allocation, the SL DRX configuration for the RX UE may be determined by the serving gNB of the TX UE; TX UE may send the SL DRX configuration to be used by the RX UE to the RX UE; The RX UE may accept or reject the SL DRX configuration.

In some examples, a default SL DRX configuration for groupcast/broadcast may be used for DCR messages.

In some examples, when the TX UE is in RRC_CONNECTED, the TX UE may report the received assistance information to its serving gNB and may send the SL DRX configuration to the RX UE upon receiving the SL DRX configuration in dedicated RRC signaling from the gNB. When the RX UE is in RRC_CONNECTED, the RX UE may report the received SL DRX configuration to its serving gNB, e.g., for alignment of the Uu and SL DRX configurations.

In some examples, SL on-duration timer, SL inactivity-timer, SL HARQ RTT timer, and SL HARQ retransmission timer may be supported in unicast. SL HARQ RTT timer and SL HARQ retransmission timer may be maintained per SL process at the RX UE. In addition to (pre) configured values for each of these timers, SL HARQ RTT timer value may be derived from the retransmission resource timing when SCI indicates more than one transmission resource.

In some examples, SL DRX MAC CE may be introduced for SL DRX operation in unicast only.

In some examples, for groupcast/broadcast, SL DRX may be configured commonly among multiple UEs based on QoS profile and Destination L2 ID. Multiple SL DRX configurations may be supported for each groupcast/broadcast.

In some examples, SL on-duration timer, SL inactivity-timer, SL HARQ RTT and SL retransmission timers may be supported for groupcast. In some examples, only SL on-duration timer may be supported for broadcast. SL DRX cycle, SL on-duration, and SL inactivity timer (only for groupcast) may be configured per QoS profile. The starting offset and slot offset of the SL DRX cycle may be determined based on the destination L2 ID. The SL HARQ RTT timer (only for groupcast) and SL HARQ retransmission timer (only for groupcast) may not be configured per QoS profile or per destination L2 ID. For groupcast, the RX UE may maintain an SL inactivity timer for each destination L2 ID, and may select the largest SL inactivity timer value if multiple SL inactivity timer values associated with different QoS profiles may be configured for that L2 ID. For groupcast and broadcast, the RX UE may maintain a single SL DRX cycle (selected as the smallest SL DRX cycle of any QoS profile of that L2 ID) and single SL on-duration (selected as the largest SL on-duration of any QoS profile of that L2 ID) for each destination L2 ID when multiple QoS profiles may be configured for that L2 ID.

In some examples, for groupcast, SL HARQ RTT timer and SL retransmission timer may be maintained per SL process at the RX UE. SL HARQ RTT timer may be set to different values to support both HARQ enabled and HARQ disabled transmissions.

In some examples, a default SL DRX configuration, common between groupcast and broadcast, may be used for a QoS profile which may not be mapped onto any non-default SL DRX configuration(s).

In some examples, in-coverage TX and RX UEs in RRC_IDLE/RRC_INACTIVE may obtain their SL DRX configuration from SIB. UEs (TX or RX) in RRC_CONNECTED may obtain the SL DRX configuration from SIB, or from dedicated RRC signaling during handover. For the out of coverage case, the SL DRX configuration may be obtained from pre-configuration.

In some examples, for groupcast, the TX UE may restart its timer corresponding to the SL inactivity timer for the destination L2 ID (used for determining the allowable transmission time) upon reception of new data with the same destination L2 ID.

In some examples, TX profile may be introduced to ensure compatibility for groupcast and broadcast transmissions between UEs supporting/not-supporting SL DRX functionality. A TX profile may be provided by upper layers to AS layer and identifies one or more sidelink feature group(s). Multiple TX profiles with the support of SL DRX and without the support of SL DRX may be associated to a destination L2 ID. A TX UE may only assume SL DRX for the destination L2 IDs when all the associated TX profiles correspond to support of SL DRX. A Tx UE may assume no SL DRX for the destination L2 ID if there is no associated TX profile. An RX UE may determine that SL DRX is used if all destination L2 IDs of interest are assumed to support SL DRX. For groupcast, the UE may report each destination L2 ID and associated SL DRX on/off indication to the gNB.

In some examples, alignment of Uu DRX and SL DRX for a UE in RRC_CONNECTED may be supported for unicast, groupcast, and broadcast. Alignment of Uu DRX and SL DRX at the same UE may be supported. In some examples, for mode 1 scheduling, the alignment of Uu DRX of the TX UE and SL DRX of the RX UE may be supported.

In some examples, alignment may comprise of either full overlap or partial overlap in time between Uu DRX and SL DRX. For SL RX UEs in RRC_CONNECTED, alignment may be achieved by the gNB.

In some examples, the SL UE in Mode 2 may support partial sensing-based resource allocation and random resource selection as power saving resource allocation methods. A SL mode 2 TX resource pool may be (pre) configured to allow full sensing only, partial sensing only, random selection only, or any combination(s) thereof. A UE may decide which resource allocation scheme(s) may be used in the AS based on its capability (for a UE in RRC_IDLE/RRC_INACTIVE/OOC) and the allowed resource schemes in the resource pool configuration.

In some examples, random resource selection is applicable to both periodic and aperiodic traffic.

In example embodiments, Sidelink (SL) may support UE-to-UE direct communication using the sidelink resource allocation modes, physical-layer signals/channels, and physical layer procedures.

In example embodiments, two sidelink resource allocation modes may be supported: mode 1 and mode 2. In mode 1, the sidelink resource allocation may be provided by the network. In mode 2, UE may decide the SL transmission resources in the resource pool(s).

In example embodiments, Physical Sidelink Control Channel (PSCCH) may indicate resource and other transmission parameters used by a UE for PSSCH. PSCCH transmission may be associated with a DM-RS.

In example embodiments, Physical Sidelink Shared Channel (PSSCH) may transmit the TBs of data themselves, and control information for HARQ procedures and CSI feedback triggers, etc. At least 6 OFDM symbols within a slot may be used for PSSCH transmission. PSSCH transmission may be associated with a DM-RS and may be associated with a PT-RS.

In example embodiments, Physical Sidelink Feedback Channel (PSFCH) may carry HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot.

In example embodiments, the Sidelink synchronization signal may consist of sidelink primary and sidelink secondary synchronization signals (S-PSS, S-SSS), each occupying 2 symbols and 127 subcarriers. Physical Sidelink Broadcast Channel (PSBCH) may occupy 9 and 7 symbols for normal and extended CP cases respectively, including the associated DM-RS.

In example embodiments, Sidelink HARQ feedback may use PSFCH and may be operated in one of two options. In one option, which may be configured for unicast and groupcast, PSFCH may transmit either ACK or NACK using a resource dedicated to a single PSFCH transmitting UE. In another option, which may be configured for groupcast, PSFCH may transmit NACK, or no PSFCH signal may be transmitted, on a resource that can be shared by multiple PSFCH transmitting UEs.

In sidelink resource allocation mode 1, a UE which received PSFCH may report sidelink HARQ feedback to gNB via PUCCH or PUSCH.

In an example, for in-coverage operation, the power spectral density of the sidelink transmissions may be adjusted based on the pathloss from the gNB.

In an example, for unicast, the power spectral density of some sidelink transmissions may be adjusted based on the pathloss between the two communicating UEs.

In an example, for unicast, channel state information reference signal (CSI-RS) may be supported for CSI measurement and reporting in sidelink. A CSI report may be carried in a sidelink MAC CE.

In example embodiments, for measurement on the sidelink, the following UE measurement quantities may be supported: PSBCH reference signal received power (PSBCH RSRP); PSSCH reference signal received power (PSSCH-RSRP); PSCCH reference signal received power (PSCCH-RSRP); Sidelink received signal strength indicator (SL RSSI); Sidelink channel occupancy ratio (SL CR); Sidelink channel busy ratio (SL CBR).

In example embodiments, side-Link on unlicensed spectrum (SL-U) for both mode 1 and mode 2 may be used. In some examples, Uu operation for mode 1 may be limited to licensed spectrum only.

Side-Link Unlicensed (SL-U) operation may utilize Channel Occupancy Time (COT) sharing between transmitting UE and receiving UEs. Existing signaling may lead to inefficiencies in COT sharing in unlicensed sidelink communications. Managing such COT sharing for unicast and/or groupcast may need enhancements to existing control signaling. Example embodiments enhance efficient Channel Occupancy Time signaling and sharing with Receiving UEs.

In example embodiments, the NR Side-Link may be expanded to other commercial use cases. In example embodiments, unlicensed bands frequencies may be used for Side-Link communications.

In example embodiments, design of Side-Link in Unlicensed spectrum (SL-U) may reuse, extend, and combine the SL resource reservation/allocation schemes with Channel Occupancy Time (COT) signaling and sharing.

In example embodiments, Physical Side-Link Shared Channel (PSSCH) and Physical Side-Link Control Channel (PSCCH) may be used for sidelink communications. A PSSCH, which contains transport blocks i.e., user data traffic, may be associated with a PSCCH. The PSCCH may be transmitted on the same slot as PSSCH and may contain control information about the shared channel. Physical Side-Link Feedback Channel (PSFCH) may be used by receiving UEs to provide their HARQ ACK/NAK feedback.

In example embodiments, a source layer-2 ID and a destination layer-2 ID may be used for Side-Link communication. The Source Layer-2 ID may identify the sender of the data in NR Side-Link communication and may be defined as a 24-bit strings consisting of two parts: the 8 bit LSB part, i.e. L1 Source IDs, may be forwarded to physical layer of the sender and may identify the source of the intended data in the SCI and may be used for filtering of packets at the physical layer of the receiver; the 16 MSB part may be carried within the MAC header and is used for filtering of packets at the MAC layer of the receiver. The Destination Layer-2 ID may identify the target of the data in NR Side-Link communication and may be defined as a 24-bit strings consisting of two parts: the 16-bit LSB part, i.e. L1 Destination IDs, may be forwarded to physical layer of the sender and may identify the target of the intended data in Side-Link control information and may be used for filtering of packets at the physical layer of the receiver. The 8 MSB part may be carried within the MAC header and may be used for filtering of packets at the MAC layer of the receiver.

In some examples, the Side-Link Control Information (SCI) may be split into two stages. The 1st stage may be sent on PSCCH, associated with the PSSCH and may be decodable and used by all UEs for resource sensing purposes, and may include the following information: Priority; Frequency and Time resource assignment; Resource reservation period; DMRS pattern and Number of DMRS port; 2nd-stage SCI format; Modulation and coding scheme. The 2nd stage SCI may be sent over the corresponding PSSCH to be received and decoded by target/destination UEs only and may include: HARQ process ID, New data indicator & Redundancy version; L1 Source and Destination IDs; CSI request.

In some examples, a channel occupancy times (COT) may be defined which may be acquired through clear channel assessment (CCA). The COT may be initiated by one node and shared with some other nodes. In some examples, the COT sharing may be used between a gNB and its target UEs and may use common DCI signaling with Format 2_0 and scrambled by SFI_RNTI providing the following information: Slot format; COT (Channel Occupancy Time) duration; Available RB set; Search space set group switching.

In some examples, the container for carrying the COT sharing information from a COT initiator UE may include at least the SCI (e.g., 1st and/or 2nd stage SCI).

In some examples, one or more of the following information may be used as part of COT sharing information from the COT initiating UE: Channel Access Priority Classes (CAPC) used for initiating the COT; source and destination IDs and/or additional ID(s); time domain information of the shared COT, starting offset, number of slots, remaining and total COT durations, frequency domain information of the shared COT, e.g., applicable RB set(s), FRIV, etc.

In some examples, SL-U design may extend Side-Link resource reservation schemes utilizing two-stage Side-Link Control Information (SCI) signaling to convey both COT reservation and sharing information.

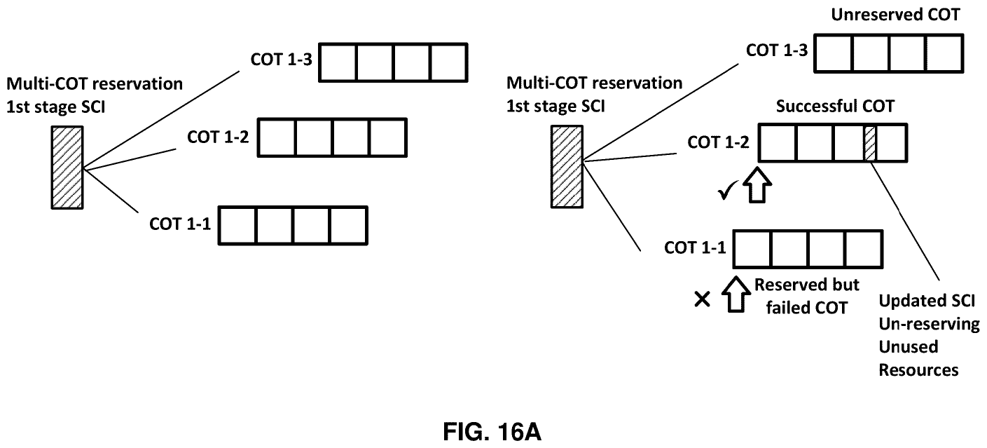

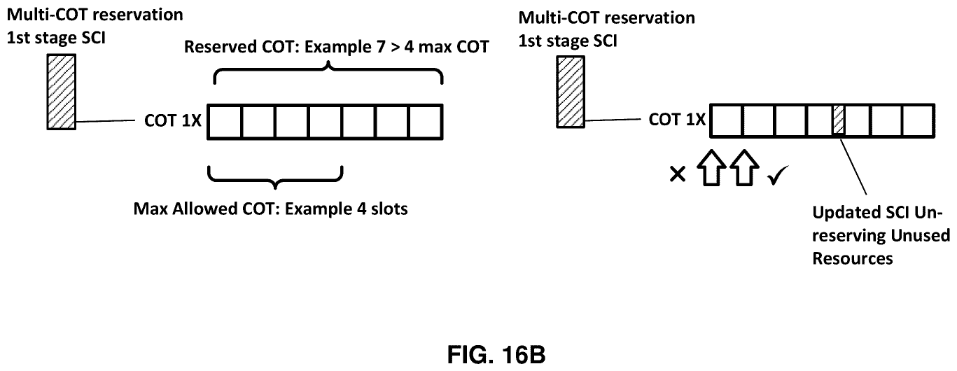

In some examples as shown in FIG. 16A and FIG. 16B, in SL-U the COT Initiating UE may need to reserve extra time and frequency resources for its target COT given some or none of those resources may not be accessible due to failed Listen Before Talk (LBT). In SL-U resources may be reserved across one or multiple RB-sets.

In some examples, in SL-U the UE may reserve extra resources over a single or multiple Channel Occupancy Times (COTs) across multiple RB sets and attempts to use them based on the outcome of Listen Before Talk (LBT).

In some examples, considering possibility of LBT failure, the COT initiating UE in SL-U may follow following options. In some examples as shown in FIG. 16B, the UE may reserve a COT that may be longer than maximum allowed by the regulation and once its COT is acquired, the UE may limit its transmission time to meet the requirement set by the Network/regulation. In some examples as shown in FIG. 16A, the COT Initiating UE may reserve multiple COTs, each within maximum allowed by Network/regulation, and may transmit on the first COT that passes LBT.

In some examples, the COT initiating UE may indicate its reserved and unused COT resources, e.g., through Stage 1 SCI signaling.

In some examples, a framework may be used by which the Base Station or select UEs may control how COT may be shared by receiving UEs. The information about priority and time and frequency resources to be reserved by COT initiating UE may be provided by all UEs to support SL Mode 2 sensing-based resource allocation. In some examples, some information related to COT sharing may be relevant to receiving UE(s).

In some examples, Stage 1 SCI may be extended and reused for SL-U COT resource reservation allowing reservation of frequency/time resources for single and multiple COTs to be receivable by all UEs.

In some examples, Stage 1 SCI in SL-U may convey the following information about upcoming Reserved COT: Priority (CAPC); frequency and Time Resource assignment/reservation (e.g., for Each COT); COT Time duration; Available RB set; Resource reservation period; DMRS pattern and Number of DMRS port; 2nd-stage SCI format; Modulation and coding scheme.

In some examples, additional 1st Stage SCI sent by COT initiating UE may be used to update time/frequency resource reservation and remove previously reserved, but not to be used, COT resources.

In some examples, in SL-U unicast, the COT initiating UE may share the COT for HARQ feedback on PSFCH or data transmission on PSSCH by the receiving UE. A receiving UE may use the shared COT to send data or other signaling such as CSI feedback to the COT Initiating UE or others. Priority factors such as CAPC of data from receiving UE may be considered in enabling COT sharing.

In some examples, SL-U COT sharing in unicast transmission may be enabled through SL-U RRC configuration by the RAN or Initiating UE. Alternatively, the specific sharing allowed for each COT may be controlled, i.e., or further limited, by COT initiating UE through SCI signaling.

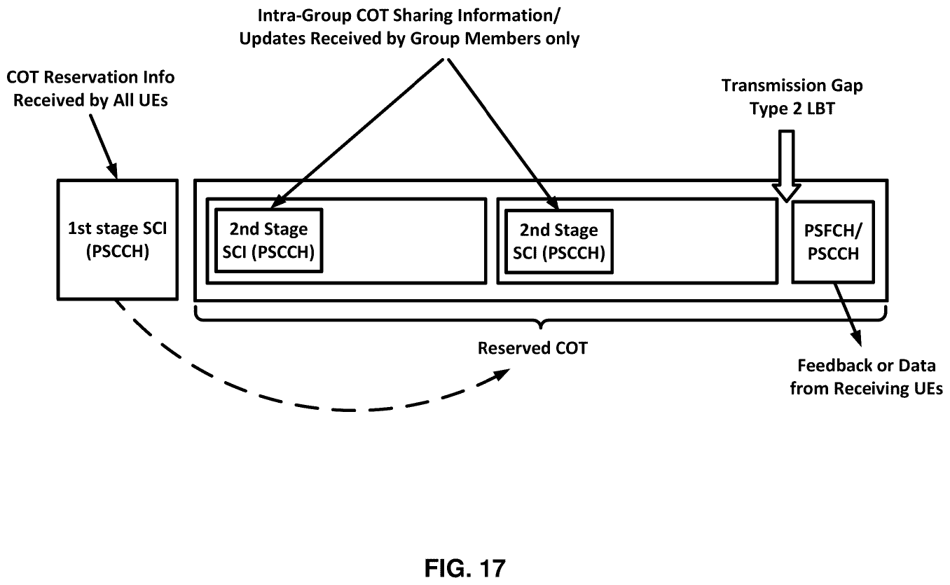

some examples as shown in FIG. 17, given COT Sharing information is relevant to target/receiving UEs, Stage 2 SCI may be used to share COT sharing information to such target UEs.

In some examples, data transmission from a receiving UE on a shared COT may be allowed subject to some traffic priority consideration, i.e., CAPC indicated in the SCI by the UE initiating COT and/or the CPAC for traffic data that receiving UE intends to transmit.

In some examples, in Multicast SL-U COT initiating UE may share its COT with receiving UEs for their HARQ feedback on PSFCH.

In some examples, in Multicast SL-U COT initiating UE may share its COT with some of the receiving UEs for their PSSCH transmission to the COT initiating UE, other members of the multicast group or other UEs not in the group.

In some examples, the SL-U Multicast (pre) configuration may define if and which types of COT sharing may be allowed for an SL-U multicast session.

In some examples, a subset of allowed COT sharing option for a SL-U multicast session may be further selected by COT initiating UE on a COT-by-COT basis through L1/2 signaling, such as Side-Link Control Information (SCI).

In some examples, the COT sharing control signaling from RAN or the COT initiating UE may include information about which COT sharing options, with PSFCH and/or PSSCH, are allowed for a given COT.

In some examples, in multicast Side-Link a COT may be shared by members of the group. In some examples, not all UEs in the group may have the same right to use the Shared COT. In some examples, the use of a shared COT by a member of group may be based on priority of the user, QoS, distance/range from TX UE, or other factors as determined centrally by network or the Initiating UE or Groupcast Leader.

In some examples, the COT sharing information may include information about which UEs in the group or others are allowed to use the shared COT.

In some examples, for COT sharing for PSFCH from target UEs the SCI may include information about ACK/NAK or NAK only HARQ feedback mode.

In some examples, the COT Sharing information set by configuration of conveys by SCI may include information about range from COT Initiating UE within which Sharing is allowed.

In some examples, multicast SL-U may be configured with a L1/L2 Multicast Destination ID which may be monitored by all UEs in the group.

In some examples, a multicast SL-U may be configured with a set of Group Destination IDs which may be RRC configured to indicate different permission for use of shared COT by receiving UEs.

In some examples, the COT Sharing for Multicasting on SL-U may include an L1/L2 Group destination ID within a set configured for the group, where each L1 Group Destination used within that set may indicate different receiving UEs's rights to use the shared COT.

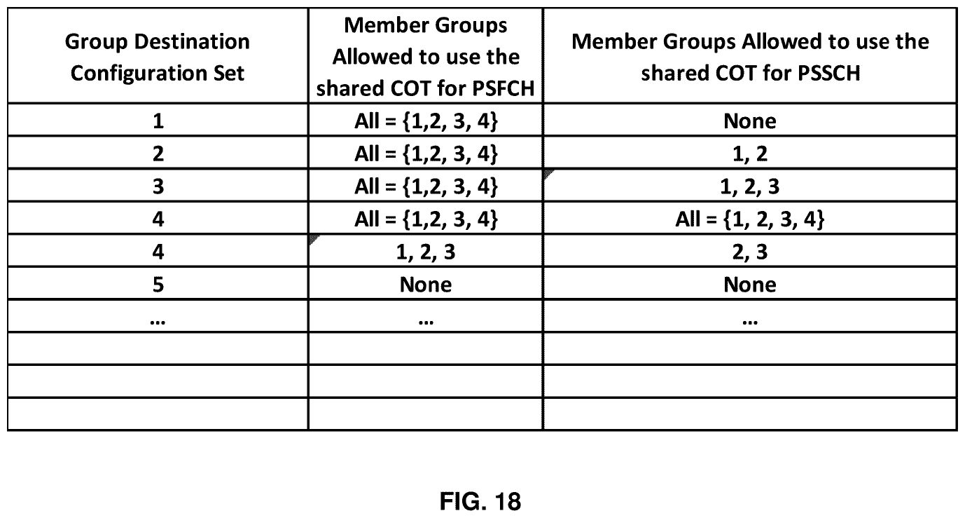

In some examples as shown in FIG. 18, a/each member of a groupcast may be assigned a short member ID (or token) at the time Group creation and or joining. Then COT sharing may be managed by indicating group members rights to use the shared COT using a configured table. For example, N least significant bits of the Group Destination ID may be used to point to a row in the table.

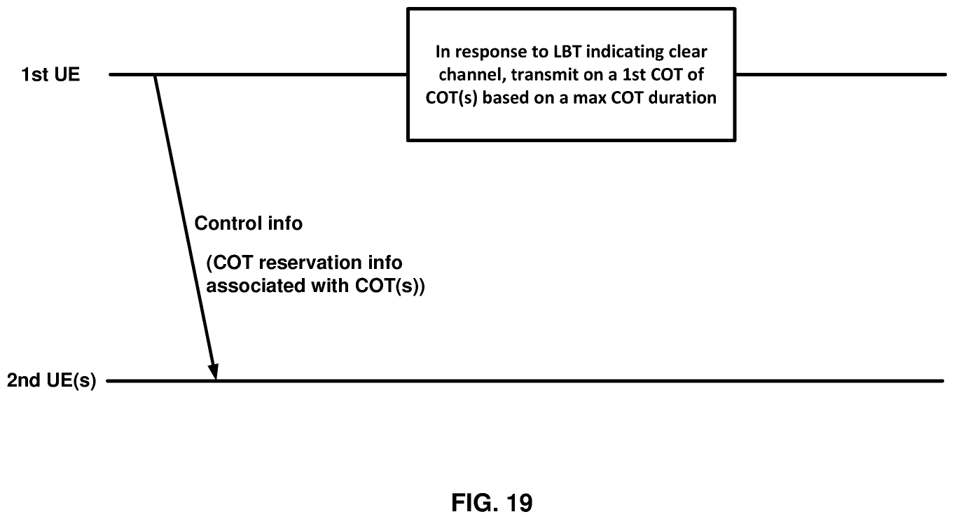

In an example embodiment as shown in FIG. 19, a first UE may transmit control information. In some examples, the control information may include sidelink control information (SCI). In some examples, the SCI may include first stage SCI (e.g., a first stage SCI transmitted via a PSCCH). In some examples, the SCI may include second stage SCI (e.g., second stage SCI transmitted via a PSSCH). In an example, the SCI may include first stage SCI (e.g., transmitted via PSCCH) and second stage SCI (e.g., transmitted via PSSCH). In some examples, some of (e.g., at least a portion of) the control information is first stage SCI and transmitted via a PSCCH and some of (e.g., at least a second portion of) the control information is transmitted via a PSSCH. The control information may include COT reservation information for/associated with one or more COTs. In some examples, the control information may further include COT sharing information (e.g., COT sharing information for/associated with the one or more COTs). The first UE may determine that the COT reservation or sharing is allowed based on/in response to receiving a configuration parameter (e.g., an RRC configuration parameter) indicating that the COT reservation/sharing is enabled/allowed. The first UE may transmit on a first COT of the one or more reserved COTs. The first UE may transmit on the first COT based on a maximum COT duration (e.g., a maximum COT duration as configured by the network or based on a regulation).

In some examples, the one or more COTs (e.g., reserved COT(s)) may comprise a plurality of COTs starting at different times. A first starting time of a first COT, of the plurality of COTs, may be different from a second starting of a second COT of the plurality of COTs. In some examples, the first COT, on which the first UE transmits, may be an earliest COT, of the plurality of COTs, for which an LBT process indicates clear channel.

In some examples, the one or more COTs (e.g., reserved COT(s)) may consist of a single COT that has an extended duration, e.g., a duration longer than the maximum duration configured or determined based on regulation. The first UE may transmit (e.g., start transmitting) in a timing within the extended COT that the LBT process indicates clear channel.

In some examples, the first UE may transmit signaling (e.g., SCI) indicating that at least a portion of the one or more reserved COTs are not used (e.g., are un-reserved).

In some examples, the control information (e.g., the SCI) may include one or more of a priority (e.g., a channel access priority class (CAPC)), frequency and time domain assignment/reservation (e.g., for each COT of the one or more COTs), a resource reservation period, a DMRS pattern and a number of DMRS ports, a second stage SCI format and an MCS.

In some examples, the control information (e.g., the SCI) may indicate an update to a pervious COT reservation or sharing information.

In some examples, based on the control information (e.g., the SCI, e.g., the first stage SCI and/or the second stage SCI) indicating COT sharing information, a second UE may share a COT based on the COT sharing information indicated by the control channel. The second UE may share the COT based on the channel access priority class (CAPA) associated with the COT. In some examples, the second UE may share the COT for transmission via a physical sidelink feedback channel (PSFCH), e.g., for transmission of HARQ feedback. The COT sharing information may indicate that COT sharing is associated with positive acknowledgement (ACK), a negative acknowledgement (NACK) and both of ACK and NACK for transmission via PSFCH. In some examples, the COT sharing information may indicate a group of one or more UEs (e.g., a multicast group) wherein the one or more UEs/UEs in the multicast group are allowed to share the COT. For example, the control information may indicate an identifier of the group/multicast group (e.g., a L1/L2 multicast destination identifier). The UE may receive a configuration parameter (e.g., an RRC configuration parameter) indicating the identifier. In some examples, the UEs that are not among the one or more UEs (e.g., the multicast group) may not be allowed to share the COT.

In an example embodiment, a first user equipment (UE) may use a method of sidelink communications. The first UE may transmit control information comprising channel occupancy time (COT) reservation information associated with one or more COTs. In response to a listen before talk (LBT) process indicating clear channel, the first UE may transmit on a first COT, of the one or more COTs, based on a maximum COT duration.

In some examples, the control information may comprise sidelink control information (SCI). In some examples, the sidelink control information (SCI) may comprise a first stage SCI. In some examples, the first stage sidelink control information (SCI) may be transmitted, by the first user equipment (UE), via a physical sidelink control channel (PSCCH). In some examples, the sidelink control information (SCI) may comprise a second stage SCI. In some examples, the second stage sidelink control information (SCI) may be transmitted, by the first user equipment (UE), via a physical sidelink shared channel (PSSCH). In some examples, the sidelink control information (SCI) may comprise a first stage SCI and a second stage SCI. At least a first portion of the channel occupancy time (COT) reservation information may be transmitted based on/via the first stage SCI and at least a second portion of the COT reservation information may be transmitted based on/via the second stage SCI.

In some examples, the one or more channel occupancy times (COTs) may comprise a plurality of COTs starting from different times. In some examples, the first channel occupancy time (COT) may be an earliest COT, in the plurality of COTs, for which a listen before talk (LBT) process indicates a clear channel.

In some examples, the one or more channel occupancy times (COTs) may consist of a single COT with an extended duration, wherein the transmitting, by the first user equipment (UE), may start in a timing within the single COT that the listen before talk (LBT) process indicates a clear channel. In some examples, the extended duration may be longer than the maximum duration. In some examples, the maximum duration may be based on a network configuration or based on a regulation.

In some examples, the maximum duration may be based on a network configuration or based on a regulation.

In some examples, the first UE may transmit signaling indicating that at least a portion of the one or more reserved channel occupancy times (COTs) are not used.

In some examples, the control information may indicate one or more of: a priority; frequency and time resource assignment; resource reservation period; demodulation reference signal (DMRS) pattern and a number of DMRS ports; a second stage sidelink control information (SCI) format; and modulation and coding scheme. In some examples, the priority may indicate a channel access priority class (CAPC). In some examples, the frequency and resource assignment may be indicated for each of one or more channel occupancy times (COTs).

In some examples, the control information may indicate an update to a previously indicated channel occupancy time (COT) information.

In some examples, the first UE may receive one or more configuration parameters indicating enabling at least one of channel occupancy time (COT) reservation and COT sharing. In some examples, the receiving the one or more configuration parameters may be based on a radio resource control (RRC) message.

In some examples, the control information may further include channel occupancy time (COT) sharing information. In some examples, the first UE may share a channel occupancy time (COT) by a second user equipment (UE) based on the COT sharing information. In some examples, the sharing of the channel occupancy time (COT) by the second user equipment (UE) may be based on a channel access priority class (CAPC) associated with the COT. In some examples, the sharing of the channel occupancy time (COT) by the second user equipment (UE) may be for transmission of hybrid automatic repeat request (HARQ) feedback. In some examples, the transmission of the hybrid automatic repeat request (HARQ) feedback may be via a physical sidelink feedback channel (PSFCH). In some examples, the channel occupancy time (COT) sharing information may indicate a group of one or more user equipments (UEs) that the COT sharing is allowed. In some examples, the group of the one or more user equipments (UEs) may be a multicast group. In some examples, other user equipments (UEs) that are not in the multicast group may not be allowed for the channel occupancy time (COT) sharing. In some examples, the channel occupancy time (COT) sharing information may indicate an identifier of the multicast group. In some examples, the identifier may be an L1/L2 multicast destination identifier. In some examples, the first UE may receive one or more configuration parameters indicating the identifier. In some examples, the receiving the one or more configuration parameters may be via a radio resource control (RRC) message. In some examples, the channel occupancy time (COT) sharing may be for a physical sidelink feedback channel (PDFCH); and the COT sharing information may indicate COT sharing is associated with which of a positive acknowledgement (ACK), a negative acknowledgement (NACK) and both of ACK and NACK.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

What is claimed is:

1. A method of sidelink communications, comprising the steps of:
transmitting, by a first user equipment (UE), control information comprising channel occupancy time (COT) reservation information associated with one or more COTs; and
in response to a listen before talk (LBT) process indicating a clear channel, transmitting on a first COT of the one or more COTs, based on a maximum COT duration.

2. The method of claim 1, wherein the control information comprises sidelink control information (SCI).

3. The method of claim 2, wherein the sidelink control information (SCI) comprises a first stage SCI.

4. The method of claim 3, wherein the first stage sidelink control information (SCI) is transmitted, by the first user equipment (UE), via a physical sidelink control channel (PSCCH).

5. The method of claim 3, wherein the sidelink control information (SCI) further comprises a second stage SCI.

6. The method of claim 5, wherein the second stage sidelink control information (SCI) is transmitted, by the first user equipment (UE), via a physical sidelink shared channel (PSSCH).

7. The method of claim 3, wherein:
the sidelink control information (SCI) comprises a first stage SCI and a second stage SCI; and
at least a first portion of the channel occupancy time (COT) reservation information associated with the one or more COTs is transmitted based on the first stage SCI and at least a second portion of said COT reservation information is transmitted based on the second stage SCI.

8. The method of claim 1, wherein each of the one or more channel occupancy times (COTs) start from different times.

9. The method of claim 8, wherein a first channel occupancy time (COT) is an earliest COT, of the one or more COTs, for which a listen before talk (LBT) process indicates a clear channel.

10. The method of claim 1, wherein the one or more channel occupancy times (COTs) consists of a single COT with an extended duration, and wherein the transmitting, by the first user equipment (UE), starts in a timing within the single COT for which the listen before talk (LBT) process indicates a clear channel.

11. The method of claim 10, wherein the extended duration is longer than the maximum channel occupancy time (COT) duration.

12. The method of claim 11, wherein the maximum channel occupancy time (COT) duration is based on a network configuration or based on a regulation.

13. The method of claim 1, wherein the maximum channel occupancy time (COT) duration is based on a network configuration or based on a regulation.

14. The method of claim 1, further comprising transmitting signaling indicating that at least a portion of the one or more reserved channel occupancy times (COTs) are not used.

15. The method of claim 1, wherein the control information indicates one or more of:
a priority;
frequency and time resource assignment;
resource reservation period;
demodulation reference signal (DMRS) pattern and a number of DMRS ports;
a second stage sidelink control information (SCI) format; and
modulation and coding scheme.

16. The method of claim 15, wherein the priority indicates a channel access priority class (CAPC).

17. The method of claim 15, wherein the frequency and resource assignment is indicated for each of one or more channel occupancy times (COTs).

18. The method of claim 1, wherein the control information indicates an update to a previously indicated channel occupancy time (COT) information.

19. The method of claim 1, further comprising receiving one or more configuration parameters indicating enabling at least one of channel occupancy time (COT) reservation and COT sharing.

20. The method of claim 19, wherein the receiving the one or more configuration parameters is based on a radio resource control (RRC) message.
